(19) United States
(12) Patent Application Publication
(10) Pub. No.: US 2026/0036333 A1
(43) Pub. Date: Feb. 5, 2026

(54) HUMIDIFIER

(71) Applicant: LG ELECTRONICS INC., Seoul (KR)

(72) Inventors: Myungjin KU, Seoul (KR); Kyoha KEUM, Seoul (KR); Kunyoung LEE, Seoul (KR); Donggun LEE, Seoul (KR); Jihye JEON, Seoul (KR)

(73) Assignee: LG ELECTRONICS INC., Seoul (KR)

(21) Appl. No.: 19/288,732

(22) Filed: Aug. 1, 2025

(30) Foreign Application Priority Data
Aug. 2, 2024 (KR) 10-2024-0103253

(51) Int. Cl. F24F 13/20; F24F 6/00

(52) U.S. Cl. CPC F24F 13/20; F24F 6/00; F24F 2006/008

(57) ABSTRACT

A humidifier including a water tank having a space configured to store water, a humidification module disposed below the water tank and configured to generate humidified air using water supplied from the water tank, a middle tray disposed between the humidification module and the water tank, and an inner shell. The middle tray includes a hole through which the humidified air generated by the humidification module is configured to flow, a tray body, a tray base disposed below the tray body, and a tray sealer disposed around the hole and configured to seal between the tray body and the tray base. The inner shell includes a discharge passage through which the humidified air is configured to flow between the water tank and the inner shell, the inner shell contacting the tray body of the middle tray.

### CROSS REFERENCE TO RELATED APPLICATIONS

This non-provisional application claims the benefit under 35 U.S.C. § 119(a) to Patent Application No. 10-2024-0103253, filed in the Republic of Korea, on Aug. 2, 2024, which is hereby expressly incorporated by reference into the present application.

### BACKGROUND OF THE INVENTION

### 1. Field of the Invention

The present disclosure relates to a humidifier, and more particularly, to a humidifier that detects water level by a weight sensor.

### 2. Description of the Related Art

A humidifier is a device that evaporates water to emit humidified air with a high moisture content.

The humidifier requires a water tank that holds water since it generates humidified air from water. The user needs to check the water level in the water tank to know when it's time to supply water to the water tank so that the humidifier can keep producing humidified air.

A floating valve, which moves as the water level changes, may be used to detect the water level in the water tank. Also, the water level may be detected by sensing the weight of the water tank.

Patent Registration No. KR 10-2505499 B1 discloses a humidifier that detects water level based on weight.

Incidentally, such a humidifier requires water not to enter a weight measurement area. Also, correct placement of the water tank in the weight measurement area is crucial for accurately detecting the water level in the water tank. Therefore, a problem exists in the related art that the weight measurement area may not accurately measure the weight of the water.

Another issue is that placing another component between the water tank and the weight measuring component can lead to challenges in accurately sensing the weight of the water tank.

### SUMMARY OF THE INVENTION

Therefore, the present disclosure has been made in view of the above problems, and it is an object of the present disclosure to solve the above-described problems and other problems.

If water or humidified air enters a structure where a weight sensor is placed, an error may occur to the operation of the weight sensor. Another object of the present disclosure is to solve this problem.

In other words, the present disclosure teaches a humidifier capable of minimizing entry of water or humidified air into a middle tray where the weight sensor is placed.

Moreover, if water enters the space where the weight sensor is placed and collects therein, an error may occur to the operation of the weight sensor. Another object of the present disclosure is to solve this problem.

That is, a humidifier that has a structure for releasing the water admitted into the middle tray to the outside is provided.

Furthermore, if there is a portion that pushes down on the middle tray, other than where the weight of the water tank is applied, or if the weight of the water tank is applied to an area other than where the weight sensor of the middle tray is placed, the weight sensor may not be able to operate properly. Another object of the present disclosure is to solve this problem.

In other words, the present disclosure has been made in an effort to provide a humidifier that allows for accurate measurement by a weight sensor, by making contact with the middle array in a direction perpendicular to a vertical direction, except for portions required to measure the weight of the water tank.

An embodiment of the present disclosure provides a humidifier including a water tank configured to form a space for storing water, and a humidification module disposed below the water tank and configured to generate humidified air using water supplied from the water tank. The humidifier includes a middle tray disposed between the humidification module and the water tank, the middle tray having a hole through which the humidified air generated by the humidification module flows, and an inner shell forming a discharge passage through which the humidified air flows between the water tank and the inner shell contacting the middle tray that forms the hole.

The middle tray includes a tray body that contacts the inner shell, and a tray base disposed below the tray body. The middle tray includes a tray sealer disposed around the hole and sealing between the tray body and the tray base.

The inner shell includes an exhaust connecting tube into which the humidified air generated from the humidification module flows, and the exhaust connecting tube contacts the tray sealer.

The tray sealer includes an inner protrusion protruding toward the center of the hole. The exhaust connecting tube contacts the inner protrusion.

The tray sealer includes an upper tray sealer disposed between the tray base and the tray body, a lower tray sealer disposed below the tray base, and a vertical portion connecting the upper tray sealer and the lower tray sealer. The inner protrusion protrudes toward the center of the hole from the vertical portion.

The inner protrusion is inclined downward toward the center of the hole.

At least one projection protruding upward toward the tray body is formed on a top surface of the upper tray sealer.

A tray drain hole is formed in the tray base to send water admitted into the middle tray out of the middle tray.

The tray drain hole is disposed at the rear of the hole. The tray base has a guide groove disposed in front of the hole and configured to guide water introduced into the middle tray to the tray drain hole.

A plurality of weight sensors for sensing the weight of the water tank and a sensor circuit board connected to the plurality of weight sensors are disposed in the middle tray. The guide groove is configured to send the water introduced into the middle tray between the weight sensors and the sensor circuit board.

A circuit board partition disposed on one side of the sensor circuit board is placed on the tray base. The guide groove is configured to send the water introduced into the middle tray to the rear of the circuit board partition.

The tray base includes a fastening portion disposed in front of the hole and configured to form a space in which a fastening member for connecting the tray body and the tray base is disposed. The fastening portion is configured to send water flowing from the guide groove between the weight sensors and the sensor circuit board.

The middle tray includes a weight sensor disposed on the tray base and configured to sense the weight of the water tank, and a sensor cover disposed on the tray body above the weight sensor and in contact with the inner shell.

The tray body includes a sensor recess opened in a region in which the sensor cover is disposed. A sensor recess flange is protruding upward from a circumferential surface of the sensor recess is disposed on the tray body.

A cover rib protruding inward is disposed on an inner circumferential surface of the sensor recess flange. The sensor cover is mounted on the cover rib.

The inner shell includes a lower protrusion protruding downward to contact the sensor cover, and an exhaust connecting tube protruding downward to admit the humidified air generated by the humidification module. When the lower protrusion contacts the sensor cover, the exhaust connecting tube contacts the tray sealer.

Another embodiment of the present disclosure provides a humidifier including a water tank configured to form a space for storing water, and a humidification module disposed below the water tank and configured to generate humidified air using water supplied from the water tank. The humidifier includes a middle tray disposed between the humidification module and the water tank, the middle tray having a hole through which the humidified air generated by the humidification module flows, and an inner shell forming a discharge passage through which the humidified air flows between the water tank and the inner shell contacting the middle tray that forms the hole.

The middle tray includes a weight sensor for sensing the weight of the water tank,

The inner shell includes a lower protrusion protruding downward to press the weight sensor, and an exhaust connecting tube protruding downward to receive the humidified air generated by the humidification module.

A lower side of the lower protrusion contacts the middle tray. A circumferential surface of the exhaust connecting tube contacts the middle tray.

The middle tray includes a tray sealer disposed around the hole and protruding toward the center of the hole. The tray sealer tube contacts the circumferential surface of the exhaust connecting tube.

The tray sealer includes an inner protrusion protruding toward the center of the hole and inclined downward toward the center of the hole. The inner protrusion contacts the circumferential surface of the exhaust connecting tube.

The humidifier further includes a supply pipe configured to send water released from the water tank to the humidification module and a connector connected to the water tank and the supply pipe to send the water held in the water tank to the supply pipe.

An inner sealer disposed on a circumferential surface of the connector. The inner sealer is disposed to contact an inner circumferential surface of the supply pipe.

The inner sealer and the circumferential surface of the supply pipe overlap 0.3 to 0.7 millimeters (mm).

Specific details of other embodiments are included in the detailed description and drawings.

A humidifier of the present disclosure has one or more of the following effects.

First, it is possible to prevent water or humidified air from entering the middle tray by placing a tray sealer where the humidified air moves. Also, it is possible to minimize the entry of humidified air by the placement and configuration of the tray sealer.

Second, a tray drain hole may be formed within the middle tray to prevent water from collecting inside. Also, a plurality of structures for guiding the admission of air to the inside may be provided to prevent water from moving to a sensor or a circuit board.

Third, a lower side of a lower protrusion of the inner shell contacts the middle tray. Meanwhile, an exhaust connecting tube of the inner shell is configured in such a way as to make contact with the sealer, and the connector also is configured in such a way that a circumferential surface thereof contacts the supply pipe. That is, an area of contact for sealing may be perpendicular to a vertical direction or be sloped, thereby allowing for accurate sensing by the weight sensor.

The effects of the present disclosure are not limited to the above-mentioned effects, and other effects that are not mentioned may be obviously understood by those skilled in the art from the claims.

### BRIEF DESCRIPTION OF THE DRAWINGS

FIG. 1 is a perspective view of a humidifier according to one embodiment of the present disclosure.

FIG. 2 is a plan view of FIG. 1.

FIG. 3 is a cross-sectional view taken along III-III′ of FIG. 2.

FIG. 4 is an exploded perspective view of an inner shell with a water tank placed therein and a middle tray according to an embodiment of the present disclosure.

FIG. 5 is a perspective view of the inner shell where the water tank is placed, according to an embodiment of the present disclosure.

FIG. 6 is a bottom view of FIG. 5.

FIG. 7 is a side view of FIG. 5.

FIG. 8 is a plan view of the middle tray according to an embodiment of the present disclosure.

FIG. 9 is a perspective view of FIG. 8.

FIG. 10 is a cross-sectional view of one side of the middle tray.

FIG. 11 is an exploded perspective view of a tray body and a tray base, according to an embodiment of the present disclosure.

FIG. 12 is a plan view of the tray base according to an embodiment of the present disclosure.

FIG. 13 is a perspective view of FIG. 11.

FIG. 14 is a cross-sectional view of one side of the inner shell with the water tank placed therein when the inner shell is placed over the middle tray, according to an embodiment of the present disclosure.

FIG. 15 is a cross-sectional view of another side of the inner shell with the water tank placed therein when the inner shell is placed over the middle tray, according to an embodiment of the present disclosure.

### DETAILED DESCRIPTION OF THE EMBODIMENTS

Advantages and features of the present disclosure and methods of achieving them will become apparent with reference to the embodiments described below in detail in conjunction with the accompanying drawings. However, the present disclosure is not limited to the embodiments disclosed below, but may be implemented in various different forms, and these embodiments are provided only to allow the disclosure of the present disclosure to be complete, and to completely inform those of ordinary skill in the art to which the present disclosure belongs, the scope of the invention, and the present disclosure is only defined by the scope of the claims. Like reference numerals refer to like elements throughout the specification.

Hereinafter, the present disclosure will be described with reference to the drawings for explaining a humidifier according to embodiments of the present disclosure.

A humidifier of the present disclosure may generate humidified air from water by ultrasonic vibration. A humidifier of the present disclosure may generate humidified air by heating water. A humidifier of the present disclosure may generate humidified air produced by ultrasonic vibration and humidified air produced by heating.

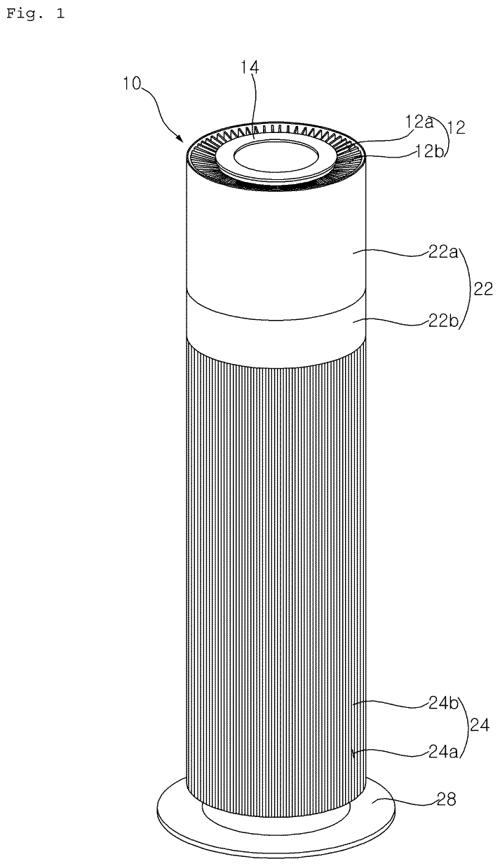

Referring to FIG. 1, an exterior of a humidifier of the present disclosure will be described.

The humidifier includes a casing 10 that forms the exterior of the humidifier, with an inlet 24a and an outlet 12a formed therein. The casing 10 may have an overall cylindrical shape.

The casing 10 may include an intake grille 24 which forms the inlet 24a through which air is admitted, and a discharge grille 12 which forms the outlet 12a through which air is discharged. The inlet 24a may be formed on a circumferential surface of the casing 10 having a cylindrical shape. In addition, the inlet 24a may be located at a lower portion of the casing 10. The outlet 12a may be formed on a top surface of the casing 10 having a cylindrical shape. The humidifier of the present disclosure may allow air to be admitted through the circumferential surface and be discharged through the top surface.

The intake grille 24 includes a plurality of grilles 24b that extend vertically. The plurality of grilles 24b may be spaced apart in a circumferential direction of the intake grille 24. A plurality of inlets 24a may be formed between the plurality of grilles 24b. The plurality of grilles 24b may span an entire circumference of the casing 10.

The casing 10 may include a water tank cover 14 disposed on top of the water tank 100.

The humidifier may include a discharge grille 12 forming the outlet 12a and a water tank cover 14 disposed on top of the water tank 100.

The discharge grille 12 may be configured to be separated upward from an outer shell 22 to be described later. The water tank cover 14 may be configured to be separated from the discharge grille 12 or from the water tank 100 to be described later.

The discharge grille 12 may include a plurality of ribs 12b that extend radially from the outer periphery of the water tank cover 14. The plurality of ribs 12b disposed at the discharge grille 12 may be spaced apart circumferentially from the outer periphery of the water tank cover 14 and may span an entire circumference of the outer periphery of the water tank.

The casing 10 may include an outer shell 22 for directing the air moving inside it to the outlet 12a.

The outer shell 22 includes an upper outer shell 22a disposed under the discharge grille 12 and a lower outer shell 22b disposed under the upper outer shell 22a. The lower outer shell 22b may be formed of a transparent material.

The humidifier may include a base 28 disposed under the casing 10, which causes the casing 10 to be spaced a certain distance apart from the ground. An upper end portion of the base 28 may be connected to a lower end portion of the casing 10. A width of the base may be larger than a width of the humidifier to increase stability of the humidifier.

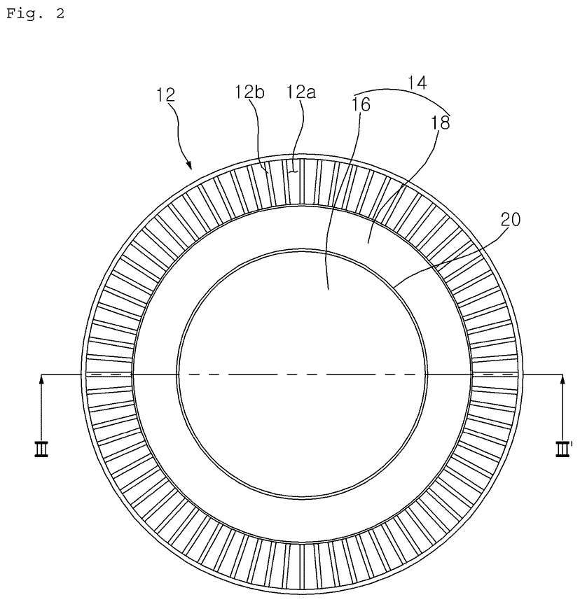

Hereinafter, a top portion of the humidifier will be described with reference to FIG. 2.

The water tank cover 14 may include a central cover 16 and a peripheral cover 18 disposed around the central cover 16. The central cover 16 may bulge upward toward the center. A water supply hole 20 may be formed between the peripheral cover 18 and the central cover 16 to allow water to move into the water tank 100.

A plurality of outlets 12a may be formed between the plurality of ribs 12b disposed at the discharge grille 12.

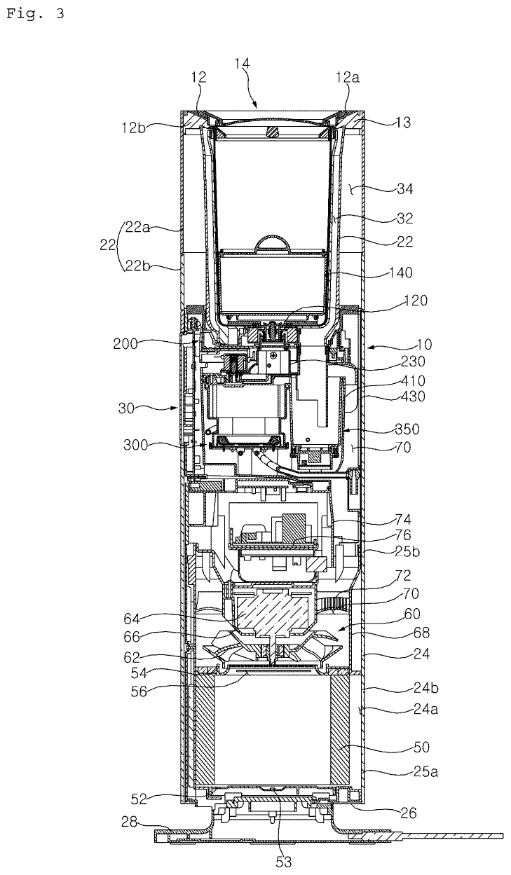

Hereinafter, an internal construction of the humidifier will be described with reference to FIG. 3.

The humidifier includes a filter unit disposed inside the casing 10, for filtering the air admitted into the inlets 24a. The humidifier includes a blower 60 disposed inside the casing 10, for moving the air inside the casing 10 from the inlets 24a to the outlets 12a. The humidifier includes a water tank 100 disposed inside the casing 10, for holding water. The humidifier includes a humidification module that generates humidified air from water supplied from the water tank 100.

The humidifier may include a base 28. The base 28 may cause the casing 10 to be spaced upward from the ground. The base 28 may be connected to a bottom wall 26 of the casing 10.

The casing 10 may include the bottom wall 26 which covers the bottom of the intake grille 24.

An upper end portion of the base 28 may be connected to the bottom wall 26. The bottom wall 26 may be disposed in such a way as to cover a bottom surface of the humidifier which is spaced upward from the ground by the base 28.

The intake grille 24 may cover the outsides of a filter 50 and a blower housing 68 to be described below. The intake grille 24 may have a plurality of inlets 24a that are vertically formed and circumferentially spaced apart. The inlets 24a may be formed around where the filter 50 is placed. The inlets 24a may be formed in a lower portion of the intake grille 24. The lower portion of the intake grille 24 may be formed with inlets 24a, and an upper portion of the intake grille 24 may be enclosed to protect the internal construction of the humidifier.

The outer shell 22 may be disposed over the intake grille 24. Specifically, the lower outer shell 22b may be disposed over the intake grille 24.

The filter unit may allow the air admitted through the inlets 24a to be filtered through the filter 50. The filter unit may allow the filtered air to move upward.

The filter unit includes a filter 50 for filtering the air admitted through the inlets 24a and a filter mounting portion for fixing the filter 50 in place inside the casing 10.

The filter 50 may be cylindrical. Thus, the filter 50 is able to filter air drawn in from longitudinal and lateral directions perpendicular to the vertical direction. The air admitted through the inlets 24a may move to an inside space of the filter 50. The air passed through the filter 50 may move to the blower 60 disposed over the filter 50.

Additionally, a filter mounting portion includes a lower plate 52 disposed on a lower side of the filter 50, an upper plate 54 disposed on an upper side of the filter 50, and a supporter connecting the lower plate 52 and the upper plate 54.

The lower plate 52 is disposed on a lower side of the filter 50. The lower plate 52 may move up and down and detect whether the filter 50 is placed.

A fan sterilizer 53 may be disposed in the center of the lower plate 52 to emit ultraviolet light upward. The fan sterilizer 53 may sterilize a blower fan 62 to be described below or the inside of the filter 50.

An orifice 56 is formed in the upper plate 54. The orifice 56 may be formed in the center of the upper plate 54. The orifice 56 may allow the air admitted to the inside of the filter 50 to move to the blower fan 62. An inner circumferential end of the upper plate 54 may be bent upward so as to guide the upward movement of air in the inside space of the filter 50 to the blower fan 62 through the orifice 56.

The supporter may connect the lower plate 52 and the upper plate 54. The supporter may be circumferentially spaced apart from a center axis of the humidifier. Further, the spacer may also be spaced apart from the orifice 56.

Next, the blower 60 includes a blower fan 62 that forms an air flow within the casing 10 and a fan motor 64 that rotates the blower fan 62.

The blower fan 62 may have a fan intake opening on one side facing the orifice 56 and a fan discharge opening on the opposite side of the fan intake opening. The blower fan 62 may be a diagonal flow fan in which the fan discharge opening on the opposite side of the fan intake opening faces in a centrifugal direction. The blower fan 62 may include a hub connected to the fan motor 64, a shroud spaced apart from the hub by a certain distance and forming the fan intake opening, and a blade extending radially to connect the hub and the shroud.

The blower fan 62 may be activated to send air upward from below. The blower fan 62 may draw air toward the orifice 56 and discharge air to the blower housing 68 where a diffuser 72 is placed.

The fan motor 64 may be disposed over the blower fan 62. Specifically, the fan motor 64 may be located over a central portion of the lower fan 62.

The blower 60 also includes a motor cover 66 that covers the outside of the fan motor 64, and a blower housing 68 spaced radially outward from the motor cover 66, that guides the upward movement of air blown by the blower fan 62.

A blower channel 70 along which the air blown by the blower fan 62 moves upward may be formed between the motor cover 66 and the blower housing 68. The blower channel 70 may extend as far as where a humidification module housing 410 and a channel housing 430 are formed.

The intake grille 24 may be disposed on the outside of the blower housing 68.

The blower 60 includes the diffuser 72 disposed between the motor cover 66 and the blower housing 68. The diffuser 72 reduces rotational components of the air blown upward by the blower fan 62. A plurality of diffusers 72 may be circumferentially spaced apart.

Additionally, a control box 74 forming a space within which a circuit board 76 is placed may be disposed over the motor cover 66. The control box 74 may be spaced apart inwardly from the blower housing 68. Thus, the blower channel 70 may be formed in the space between the control box 74 and the blower housing 68 as well.

A plurality of circuit boards 76 may be placed within the control box 74. The humidification module includes a first humidification reservoir 300 which heats water. Also, the humidification module includes a second humidification reservoir 350 which generates humidified air from water. The humidification module may include a humidification module housing 410 which covers the peripheries of the first humidification reservoir 300 and the second humidification reservoir 350. The channel housing 430 may be disposed around the outer periphery of the humidification module housing 410. Further, the blower channel 70 may be formed between the humidification module housing 410 and the channel housing 430.

The humidifier includes a water tank 100 forming a space in which water is held, an inner shell 180 forming a space in which the water tank 100 is placed, and a middle tray 200 disposed under the inner shell 180.

The water tank 100 may have an inner reservoir 102 placed inside an outer reservoir 160. Thus, a connector 120 may be placed in a through-hole 164 of the outer reservoir 160.

The outer reservoir 160, while placed inside the inner shell 180, may be disposed over the middle tray 200. The middle tray 200 may be a structure that supports the outer reservoir 160 and the inner reservoir 102. Thus, a loads of the inner reservoir 102, the outer reservoir 160, and the inner shell 180 may be transferred to the middle tray 200.

The outer reservoir 160 is placed around the outer periphery of the inner reservoir 102. The inner reservoir 102 may be placed inside the outer reservoir 160. When the inner reservoir 102 is placed inside the outer reservoir 160, an outer circumferential surface of the inner reservoir 102 may be disposed in such a way as to make contact with an inner circumferential surface of the outer reservoir 160.

In addition, the humidifier includes a water softener 140 placed within the inner reservoir 102. The water softener 140 may be located at a bottom of the inner reservoir 102.

The water softener 140 is placed inside the inner reservoir 102. The water softener 140 may be fixed in place as it is connected to the connector 120 placed inside the inner reservoir 102.

The inner shell 180 is spaced apart from the outer reservoir 160. The inner shell 180 is spaced apart from the water tank 100. A first discharge passage 32 along which humidified air moves is formed between the inner shell 180 and the outer reservoir 160.

A second discharge passage 34 is formed between the outer shell 22 and the inner shell 180. Additionally, a width of the second discharge passage 34 may be larger than a width of the first discharge passage 32.

The inner shell 180 and the outer shell 22 are spaced apart from each other and form the second discharge passage 34. Filtered clean air blown by the blower 60 may move along the second discharge passage 34.

The discharge grille 12 may be disposed over the first discharge passage 32 and the second discharge passage 34 which will be described below.

The discharge grille 12 may be a certain height in the vertical direction. Thus, a mixture passage 13 may be formed between the plurality of ribs 12b of the discharge grille 12. The mixture path 13 may be located at an upper portion of the humidifier. In the mixture passage 13, the air moving through the first discharge passage 32 and the air moving through the second discharge passage 34 may be mixed together.

The plurality of ribs 12b may be formed in such a way that outer peripheral ends of the plurality of ribs 12b are disposed higher than inner peripheral ends of the plurality of ribs 12b. Thus, the air moving through the first discharge passage 32 and the second discharge passage 34 may be guided radially inwardly.

Next, a display 30 is disposed on one side of the casing 10. The display 30 allows the user to control the power or operation of the humidifier. The display 30 may be a display that shows the operating status or the like of the humidifier to the user.

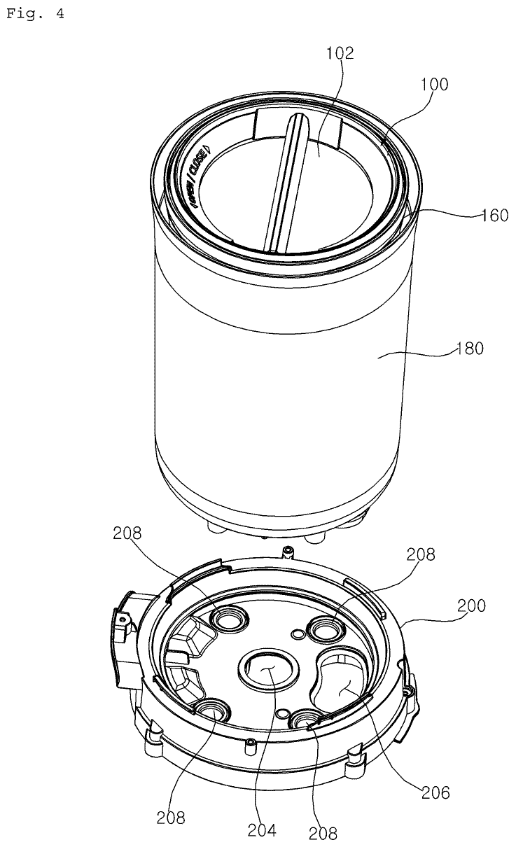

Referring to FIG. 4, the middle tray 200, the inner shell 180, and the water tank 100 will be described.

The water tank 100 may be placed within the inner shell 180. Further, the inner reservoir 102 and the outer reservoir 160 may be placed within the inner shell 180.

The inner shell 180 may be disposed over the middle tray 200.

The middle tray 200 may be disposed over the humidification module. Additionally, the middle tray 200 may be disposed between the humidification module and the water tank 100. The middle tray 200 may have a first hole 204 for a supply pipe to penetrate and a second hole 206 for the humidified air generated by the humidification module to move through. The first hole 204 may be located at a central portion of the middle tray 200.

A plurality of sensor recesses 208 and a plurality of projections may be formed on the middle tray 200 to fix the overlying inner shell 180 in place.

Weight sensors 226 and 227 may be disposed under the sensor recesses 208.

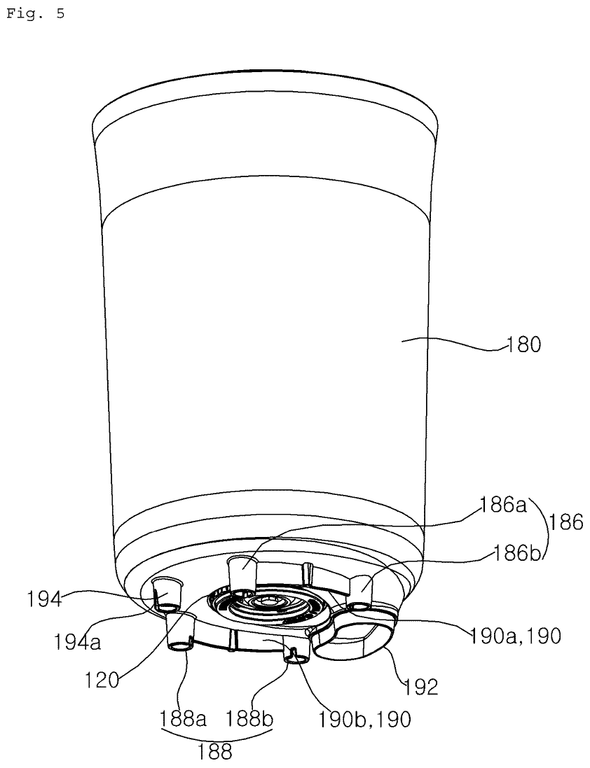

Referring to FIGS. 5 through 7, a structure of the inner shell 180 will be described.

The water tank 100 and the connector 120 are placed within the inner shell 180. Part of the construction of the connector 120 may be exposed out of the inner shell 180.

The inner shell 180 forms a space inside where the water tank 100 is placed. Further, the inner shell 180 is configured to be connected to the water tank 100. Thus, when the inner shell 180 is placed over the middle tray 200, a load of the water tank 100 also may be transferred to the middle tray 200.

The inner shell 180 has a structure in which a top surface thereof is open. A shell through-hole 184 is formed in a bottom surface of the inner shell 180, for part of the construction of the connector 120 to penetrate. The shell through-hole 184 is disposed over the first hole 204 of the middle tray 200.

An exhaust connecting tube 192 is disposed on the bottom surface of the inner shell 180 to supply the humidified air released from the humidification module to the first discharge passage 32. The exhaust connecting tube 192 is disposed over the second hole 206 of the middle tray 200.

A plurality of lower protrusions 186 and 188 are disposed on the bottom surface of the inner shell 180, placed over the weight sensors 226 and 227 of the middle tray 200 and spaced apart longitudinally or laterally. The plurality of lower protrusions 186 and 188 protrude downward from the bottom surface of the inner shell 180. Further, the plurality of lower protrusions 186 and 188 may be symmetrical to each other.

Four lower protrusions 186 and 188 are disposed on the bottom surface of the inner shell 180, spaced apart longitudinally and laterally.

A lower rib 190 is disposed on the bottom surface of the inner shell 180 to connect together two lower protrusions 186 and 188 that are spaced longitudinally. When the inner shell 180 is placed over the middle tray 200, the lower rib 190 may be spaced a certain distance upward from a upper surface of the middle tray 200.

Two lower ribs 190 are disposed on the bottom surface of the inner shell 180, spaced apart laterally. The two lower ribs 190 are disposed on the left and right sides of the shell through-hole 184. A first lower rib 190a disposed on one side of the shell through-hole 184 and a second lower rib 190b disposed on the other side of the shell through-hole 184 are disposed on the bottom surface of inner shell 180. The first lower rib 190a and the second lower rib 190b may be symmetrical to each other.

A fixing projection 194 is disposed on the bottom surface of the inner shell 180 to fix the inner shell 180 in place. The fixing projection 194 is disposed at the front of the bottom surface of the inner shell 180. The fixing projection 194 is disposed in front of the exhaust connecting tube 192. The fixing projection 194 is disposed in front of the shell through-hole 184.

A fixing slit 194a is formed at one portion of a circumferential surface of the fixing projection 194. A fixing rib 212 of the middle tray 200 to be described later may be inserted into the fixing slit 194a.

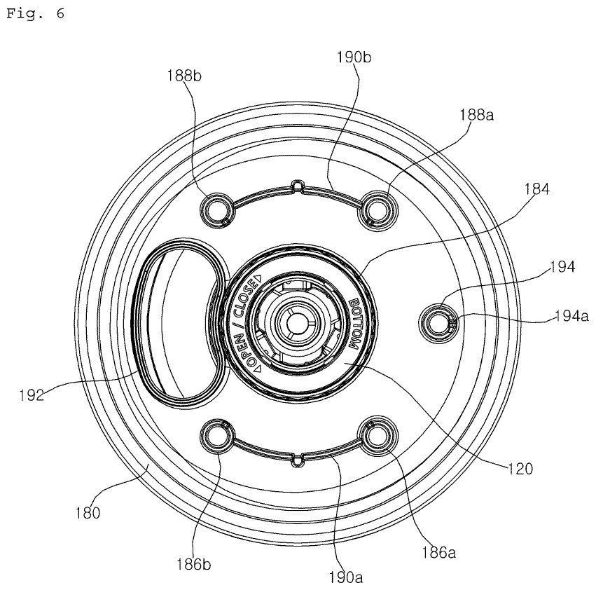

Referring to FIG. 6, a configuration of components on the bottom surface of the inner shell 180 will be described.

The shell through-hole 184 is formed in the center of the inner shell 180. Part of the construction of the connector 120 is placed in the shell through-hole 184.

The exhaust connecting tube 192 is disposed at the rear of the shell through-hole 184. The fixing projection 194 is disposed in front of the shell through-hole 184. The fixing slit 194a is formed in front of the fixing projection 194.

The plurality of lower protrusions 186 and 188 are disposed on the left and right sides of the shell through-hole 184.

First lower protrusions 186 disposed on one side of the shell through-hole 184 and second lower protrusions 188 disposed on the opposite side of the first lower protrusions 186 relative to the shell through-hole 184 are formed on the bottom surface of the inner shell 180.

The first lower protrusions 186 include a first front lower protrusion 186a and a first rear lower protrusion 186b disposed at the rear of the first front lower protrusion 186a. The first lower rib 190a connects the first front lower protrusion 186a and the first rear lower protrusion 186b. In addition, the first lower rib 190a may connect the first front lower protrusion 186a and the first rear lower protrusion 186b with a curved surface.

The second lower protrusions 188 include a second front lower protrusion 188a and a second rear lower protrusion 188b disposed at the rear of the second front lower protrusion 188a. The second lower rib 190b connects the second front lower protrusion 188a and the second rear lower protrusion 188b. In addition, the second lower rib 190b may connect the second front lower protrusion 188a and the second rear lower protrusion 188b with a curved surface.

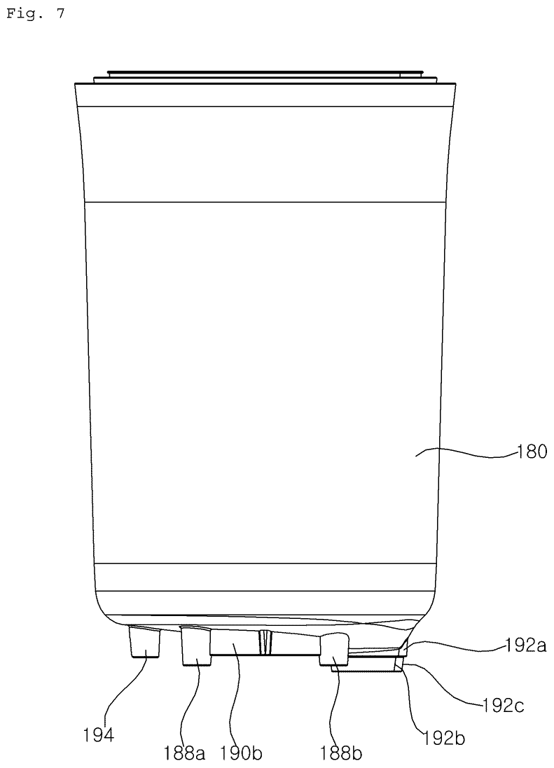

Referring to FIG. 7, the heights of components on the bottom surface of the inner shell 180 will be described.

Lower ends of the plurality of lower protrusions 186 and 188 may be formed at the same vertical position.

Lower ends of the lower ribs 190 may be disposed higher than the lower ends of the lower protrusions 186 and 188. A lower end of the fixing projection 194 may be disposed higher than the lower ends of the lower protrusions 186 and 188. A lower end of the exhaust connecting tube 192 may be disposed lower than the lower ends of the lower protrusions 186 and 188.

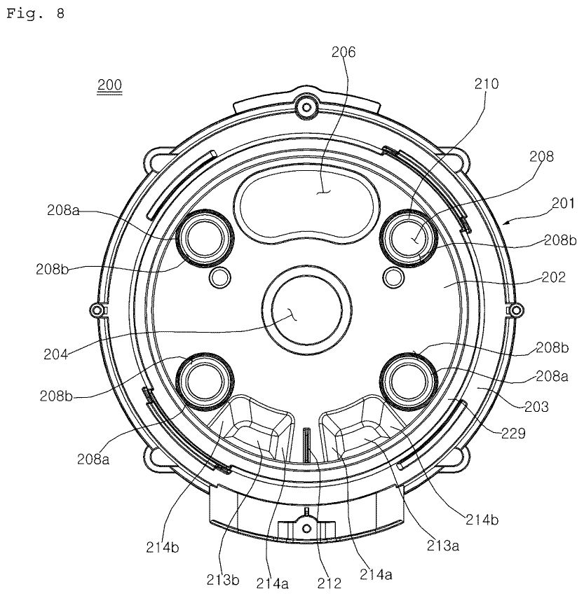

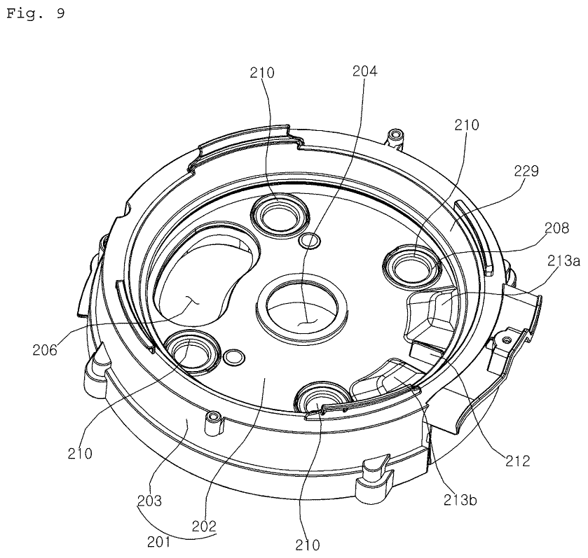

Hereinafter, the middle tray 200 will be described with reference to FIGS. 8 and 9.

The humidifier includes a middle tray 200 that separates an area where the water tank 100 is placed and an area where the humidification module is placed. The middle tray 200 may detect the water level in the water tank 100. The middle tray 200 may emit light onto discharged humidified air.

The middle tray 200 is disposed under the water tank 100. The middle tray 200 is disposed under the inner shell 180. Further, the middle tray 200 is disposed over the humidification module. The weight sensors 226 and 227 may be disposed on the middle tray 200 to detect the water level in the water tank 100 by their weight.

A lamp 229a may be disposed on the middle tray 200 to emit light toward the first discharge passage 32. The lamp 229a may be located at an edge portion of the middle tray 200.

The middle tray 200 includes a tray body 201 and a lamp housing 229 disposed around an inner circumferential surface of the tray body 201.

The tray body 201 includes a tray plate 202 where the inner shell 180 is seated and a tray peripheral wall 203 disposed around the lamp housing 229. The lamp housing 229 may be located between the tray plate 202 and the tray peripheral wall 203.

A plurality of sensor recesses 208 are formed on a upper surface of the tray body 201, set back downwardly for the plurality of lower protrusions 186 and 188 of the inner shell 180 to be inserted therein. Here, the upper surface of the tray body 201 may be a upper surface of the tray plate 202.

A plurality of sensor recesses 208 are formed on the upper surface of the middle tray 200. The plurality of sensor recesses 208 are spaced laterally and longitudinally and may be located symmetrically to each other.

A sensor recess flange 208a protrudes upward on a circumferential surface of each of the plurality of sensor recesses 208. A rib hole 208b is formed at one portion of the circumferential surface of the sensor recess flange 208a, for the lower rib 190 to penetrate. The rib hole 208b is formed where the lower rib 190 is disposed.

A sensor cover 210 is disposed at each of the plurality of sensor recesses 208. The sensor cover 210 is disposed under the sensor recess flange 208a. The sensor cover 210 may prevent water from moving to the weight sensor 226 and 227 through the sensor recess 208.

The plurality of lower protrusions 186 and 188 of the inner shell 180 may be disposed at the plurality of sensor recesses 208, respectively.

The fixing rib 212 is disposed on the upper surface of the middle tray 200. The fixing rib 212 connected to the fixing projection 194 of the inner shell 180 protrudes on the upper surface of the tray body 201.

The fixing rib 212 is inserted into the fixing slit 194a formed at the fixing projection 194.

A pair of fixing protrusions 213a and 213b are disposed on the upper surface of the middle tray 200, spaced apart on either side of the fixing rib 212. The pair of fixing protrusions 213a and 213b are laterally spaced apart from the fixing rib 212. The pair of fixing protrusions 213a and 213b may make contact with a circumferential surface of the fixing projection 194 of the inner shell 180.

The pair of fixing protrusions 213a and 213b each may have a downward-inclined surface corresponding to a portion of a upper surface thereof. Thus, when the inner shell 180 is placed over the middle tray 200, the pair of fixing protrusions 213a and 213b each may guide the fixing projection 194 in such a way as to be connected to the fixing rib 212.

The pair of fixing protrusions 213a and 213b each include a first inclined surface 214a which is sloped in the direction in which the fixing rib 212 is disposed. The first inclined surface 214a may guide the fixing projection 194 in such a way as to be connected to the fixing rib 212.

The pair of fixing protrusions 213a and 213b each include a second inclined surface 214b which is sloped in the direction in which the sensor recess 208 is disposed. The second inclined surface 214b may form a slope in the direction in which a contiguous sensor recess 208 is disposed. The second inclined surface 214b may guide the lower protrusion 186 and 188 in such a way as to be disposed in the sensor recesses 208.

The first hole 204 is formed on one side of the tray body 201, for a supply pipe 230 to penetrate. The first hole 204 may be formed in the center of the tray body 201. Part of the supply pipe 230 is disposed over the first hole 204. The connector 120 of the inner reservoir 102 may be connected to the supply pipe 230 disposed over the first hole 204. The first hole 204 may be located in between the plurality of sensor recesses 208.

A first flange is disposed around the first hole 204, protruding upward from the tray body 201. Thus, it is possible to prevent water admitted to the top of the tray body 201 from moving downward from the middle tray 200.

A second hole 206 is formed on the other side of the tray body 201 to allow the humidified air released from the humidification module to move through. The exhaust connecting tube 192 is disposed over the second hole 206. The second hole 206 may be located between two sensor recesses 208 of the plurality of sensor recesses 208.

A second flange is disposed around the second hole 206, protruding upward from the tray body 201. The second flange may prevent the water admitted to the top of the tray body 201 from moving downward from the middle tray 200 through the second hole 206.

The lamp housing 229 is disposed along the periphery of the tray body 201. The lamp housing 229 may be formed in a ring shape. A lamp 229a may be disposed within the lamp housing 229 to emit light upward. One side of the lamp housing 229 may be formed of a material that transmits the light emitted from the lamp 229a.

The middle tray 200 may be disposed in such a way as to cover the top sides of the first humidification reservoir 300 and the second humidification reservoir 350.

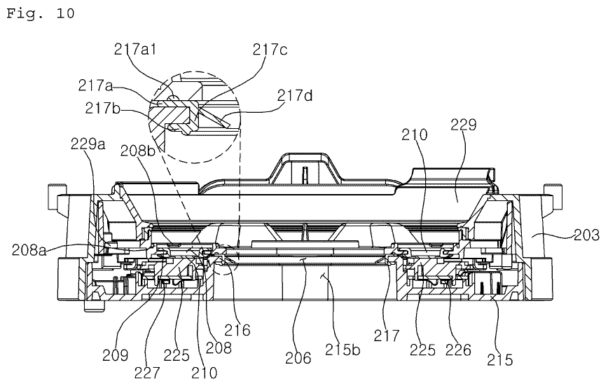

The first hole 204 (or hole) may be formed in the middle tray 200 so as to supply the water held in the water tank to the humidification module. The plurality of weight sensors 226 and 227 (see FIG. 10) are disposed at symmetrical positions on the middle tray 200.

The plurality of weight sensors 226 and 227 are respectively disposed under the plurality of sensor recesses 208 formed on the middle tray 200.

The plurality of weight sensors 226 and 227 are disposed symmetrically with respect to the first hole 204. An imaginary line connecting each pair of weight sensors 226 and 227 placed on opposite sides relative to the first hole 204 passes through the first hole 204.

The plurality of weight sensors 226 and 227 may be equally spaced from the center of the first hole 204.

The center point of a polygon formed by the plurality of weight sensors 226 and 227 lies at the first hole 204. An arrangement of the plurality of weight sensors 226 and 227 disposed under the plurality of sensor recesses 208 forms a polygonal structure. As such, the center point of the polygonal structure formed by the arrangement of the plurality of weight sensors 226 and 227 lies at the first hole 204.

Here, the center point may be the center of the area of the polygonal structure.

Referring to FIG. 10, components of the middle tray in relation to the weight sensors and connections between them will be described.

The middle tray 200 includes the tray body 201 and the tray base 215 disposed under the tray body 201. A space within which the components are placed is formed between the tray base 215 and the tray body 201.

The tray body 201 includes a tray plate 202 forming a top surface and a tray peripheral wall 203 forming a circumferential surface.

The lamp housing 229 is disposed between the tray plate 202 and the tray peripheral wall 203.

The weight sensors 226 and 227 are placed on the tray base 215. A press body 225 is disposed above each of the weight sensors 226 and 227. A sensor cover 210 is placed over the press body 225.

The sensor recesses 208 are formed on the tray plate 202. Sensor recess flanges 208a are disposed on the tray plate 202, protruding upward from the peripheries of the sensor recesses 208. Cover ribs 209 are disposed on the tray plate 202, protruding inward from where the sensor recesses 208 are formed. The cover ribs 209 protrude inward from lower end portions of the sensor recess flanges 208a.

The sensor cover 210 may be mounted on each of the cover ribs 209. The sensor cover 210 may be formed in such a way that an outer peripheral edge thereof covers the cover rib 209. Further, the sensor cover 210 may be formed in such a way that an outer peripheral edge thereof covers the top and bottom of the cover rib 209.

Additionally, the sensor cover 210 may be disposed in such a way as to make contact with the press body 225. The sensor cover 210 may prevent water from entering the middle tray 200 through the sensor recess 208.

An exhaust hole 215b is formed in the tray base 215, under the second hole 206. A width of the exhaust hole 215b may be smaller than a width of the second hole 206. An exhaust hole rib 216 is disposed on the tray base 215, protruding inward from where the exhaust hole 215b is formed. The exhaust hole rib 216 is disposed under the tray plate 202.

A tray sealer 217 is disposed at the exhaust hole 215b formed in the tray base 215 to prevent water from entering an inside space of the middle tray 200.

The tray sealer 217 has a structure that covers upper and lower parts of the exhaust hole rib 216. The tray sealer 217 includes an upper tray sealer 217a disposed over the exhaust hole rib 216, a lower tray sealer 217b disposed under the exhaust hole rib 216, and a vertical portion 217c connecting the upper tray sealer 217a and the lower tray sealer 217b.

At least one projection 217al is formed on a top surface of the upper tray sealer 217a, protruding upward toward the tray body 201.

An inner protrusion 217d is formed on an inner peripheral edge of the tray sealer 217, protruding radially inward. The inner protrusion 217d protrudes inward toward the exhaust hole 215b from the vertical portion 217c. The inner protrusion 217d may be sloped downward toward the center of the exhaust hole 215b.

The lamp 229a may be disposed under the lamp housing 229.

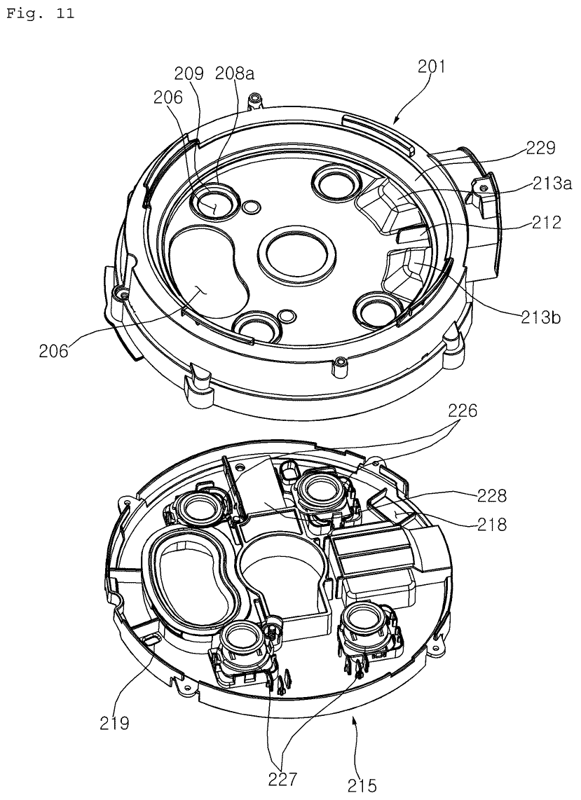

Referring to FIG. 11, a structure of the middle tray will be described additionally.

As discussed above, the middle tray 200 includes the tray body 201 and the tray base 215. The lamp housing 229 is placed on the tray body 201.

The tray body 201 has the first hole 204 for the supply pipe 230 to penetrate and the second hole 206 for the humidified air generated by the humidification module to move through. The tray body 201 has the plurality of sensor recesses 208 for fixing the inner shell 180 in place.

The sensor recess flanges 208a, which respectively protrudes upward from the circumferential surfaces of the plurality of sensor recesses 208, and the cover ribs 209, which respectively protrude inward from where the plurality of sensor recesses 208 are formed, are disposed on the tray body 201.

The fixing rib 212 and the pair of fixing protrusions 213a and 213b disposed on either side of the fixing rib 212 and spaced apart from each other, are disposed on the tray body 201.

A supply pipe hole 215a formed under the first hole 204 and an exhaust hole 215b formed under the second hole 206 are formed in the tray base 215.

The plurality of weight sensors 226 and 227 are placed on the tray base 215. The plurality of weight sensors 226 and 227 are respectively disposed under the plurality of sensor recesses 208 formed on the tray body 201. One weight sensor of the plurality of weight sensors 226 and 227 may be located at each of the plurality of sensor recesses 208.

On the tray base 215, a plurality of press bodies 225 are disposed over the plurality of weight sensors 226 and 227, respectively. The plurality of press bodies 225 are disposed in such a way as to make contact with the plurality of weight sensors 226 and 227, respectively.

A sensor circuit board 228 connected to the plurality of weight sensors 226 and 227 is placed on the tray base 215.

A wire hole 218 through which a wire passes is formed in the tray base 215. The wire hole 218 may be located at an edge portion of the tray base 215.

A tray drain hole 219 is formed in the tray base 215 to send water admitted into the middle tray 200 to the outside. The tray drain hole 219 may be located at an opposite side of the tray base than the wire hole 218.

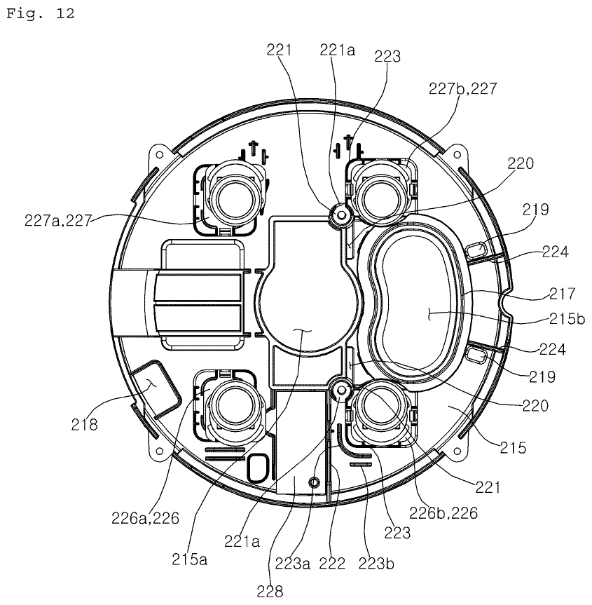

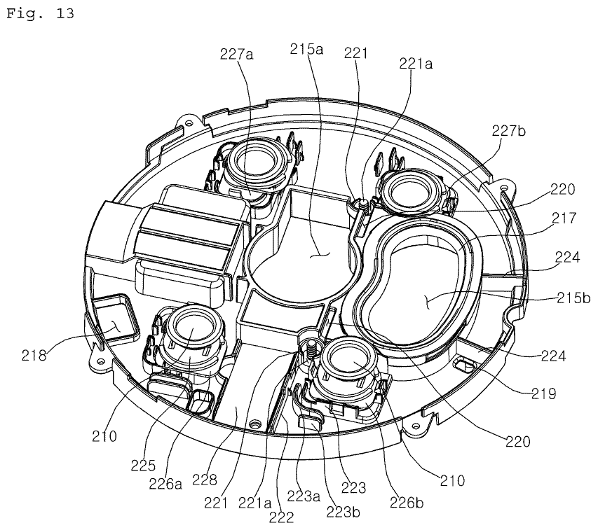

Referring to FIGS. 12 and 13, a drainage structure inside the tray base will be described.

The tray sealer 217 is disposed around the exhaust hole 215b. The tray sealer 217 may prevent water from getting inside through the gap between the tray body 201 and the tray base 215.

The plurality of weight sensors 226 and 227 are placed on the tray base 215. On the tray base 215, first weight sensors 226 are disposed on one side of the supply pipe hole 215a, and second weight sensors 227 are disposed on the opposite side of the first weight sensors 226 relative to the supply pipe hole 215a.

The first weight sensors 226 include a first front weight sensor 226a and a first rear weight sensor 226b disposed at the rear of the first front weight sensor 226a. The second weight sensors 227 include a second front weight sensor 227a and a second rear weight sensor 227b disposed at the rear of the second front weight sensor 227a.

The sensor circuit board 228 is disposed between the first front weight sensor 226a and the first rear weight sensor 226b.

A circuit board partition 222 is placed on the tray base 215, protruding upward from the rear of the sensor circuit board 228.

The sensor circuit board 228 is disposed in front of the exhaust hole 215b. The sensor circuit board 228 is disposed on one lateral side of the supply pipe hole 215a.

The first rear weight sensor 226b and the second rear weight sensor 227b are disposed on either side of the exhaust hole 215b. The exhaust hole 215b is disposed between the first rear weight sensor 226b and the second rear weight sensor 227b.

The first rear weight sensor 226b is disposed at the rear of the sensor circuit board 228.

A pair of guide grooves 220 are formed in front of the exhaust hole 215b to guide the movement of water admitted through the exhaust hole 215b. The pair of guide grooves 220 each have a structure that extends laterally. The pair of guide grooves 220 each send water admitted through a peripheral area of the exhaust hole 215b to the fronts of the first rear weight sensor 226b and the second rear weight sensor 227b.

One of the pair of guide grooves 220 sends the water admitted through the peripheral area of the exhaust hole 215b to a space between the first rear weight sensor 226b and the sensor circuit board 228.

In addition, a pair of fastening portions 221 connecting the tray body 201 and the tray base 215 are disposed in front of the exhaust hole 215b. Each of the fastening portions 221 forms a space where a fastening member is placed.

Each of the fastening portions 221 has an opening 221a on one side. The openings 221a respectively formed on the pair of fastening portions 221 are formed in such a way as to face the fronts of the first rear weight sensor 226b and the second rear weight sensor 227b, respectively.

Water moving along the pair of guide grooves 220 may move to the pair of fastening portions 221, respectively. The water moving to the pair of fastening portions 221 may move to the fronts of the first rear weight sensor 226b and the second rear weight sensor 227b.

The water moving to one of the pair of fastening portions 221 may move between the first rear weight sensor 226b and the sensor circuit board 228 through the opening 221a.

On the tray base 215, upward-protruding ridges may be formed where the weight sensors 226 and 227a are placed. On the tray base 215, weight sensor partitions 223 may be disposed around where the weight sensors 226 and 227 are placed.

The tray drain hole 219 is disposed at the rear of the exhaust hole 215b. Water admitted to the rear of the exhaust hole 215b may move directly to the tray drain hole 219. The tray drain hole 219 may be located adjacent to a drain hole partition 224.

Incidentally, the water admitted to the front of the exhaust hole 215b may move along the peripheries of the weight sensors 226 and 227 through the guide grooves 220 and then move to the tray drain hole 219. The water admitted to the front of the exhaust hole 215b may move to the tray drain hole 219 through the guide grooves 220 and the fastening portions 221.

The drain hole partition 224 is disposed at the rear of the tray base 215. The drain hole partition 224 is disposed on one side of the tray drain hole 219. Further, the drain hole partition 224 allows water moving along the tray base 215 to be drained through the tray drain hole 219.

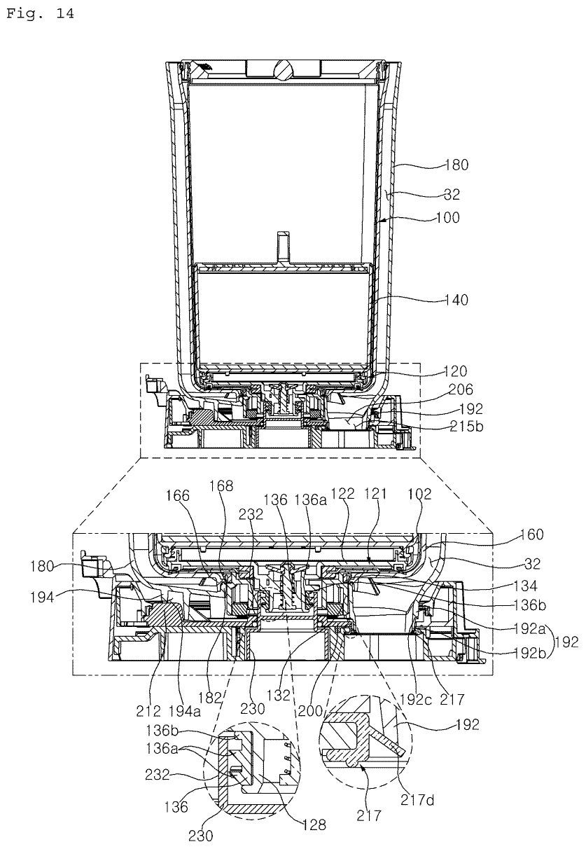

Referring to FIG. 14, the connection between the middle tray 200 and the inner shell 180 while the inner shell 180 is mounted and the configuration of the components related thereto will be described. Also, the connections between the inner shell, the water tank, and the supply pipe will be described.

The first discharge passage 32 is formed between the inner shell 180 and the water tank 100.

The water softener 140 is placed within the water tank 100. The water softener 140 may be placed at a lower portion of the water tank 100.

The fixing rib 212 of the middle tray 200 is inserted into the fixing slit 194a formed on the fixing projection 194 on the inner shell 180. With the fixing rib 212 inserted in the fixing slit 194a, an upper end of the fixing rib 212 is disposed to be spaced apart from the inner shell 180. Thus, the load of the inner shell 180 is not transferred to the fixing rib 212.

The exhaust connecting tube 192 on the inner shell 180 is inserted into the second hole 206 of the middle tray 200. The exhaust connecting tube 192 is disposed in such a way as to make contact with the tray sealer 217. The exhaust connecting tube 192 is disposed over the tray sealer 217.

The tray sealer 217 is sloped downward. Thus, the exhaust connecting tube 192 on the inner shell 180 is disposed over the tray sealer 217 to make contact with it.

The exhaust connecting tube 192 includes a first exhaust connecting tube 192a disposed over the middle tray 200 and a second exhaust connecting tube 192b extending downward from the first exhaust connecting tube 192a. A stepped portion 192c is formed between the first exhaust connecting tube 192a and the second exhaust connecting tube 192b. A lower end of the first exhaust connecting tube 192a is spaced a certain distance upward from the upper surface of the middle tray 200.

The second exhaust connecting tube 192b penetrates the second hole 206. A lower end portion of the second exhaust connecting tube 192b is disposed in such a way as to make contact with the tray sealer 217.

In addition, the supply pipe 230 may be connected to the connector 120 via the first hole 204 of the middle tray 200.

Hereinafter, the connections between the inner shell, the water tank, the connector, and the supply pipe which are disposed above or below the middle tray will be described additionally.

The inner reservoir 102 is disposed within the outer reservoir 160. The inner reservoir 102 is disposed in such a way to make contact with the outer reservoir 160. The outer reservoir 160 includes a lower rim 166 protruding downward from a lower surface of the outer reservoir 160.

An inner projection 168 is disposed on an inner circumferential surface of the lower rim 166, protruding inward. The inner projection 168 is disposed in such a way as to make contact with an outer sealer 134 of a connector holder 132. The inner projection 168 is disposed over the upper rim 182 of the inner shell 180.

The inner shell 180 is placed around the periphery of the outer reservoir 160. The outer reservoir 160 and the inner shell 180 are spaced apart from each other. The first discharge passage 32 is formed between the outer reservoir 160 and the inner shell 180.

Part of the connector 120 is disposed in such a way as to penetrate the bottom surface of the inner shell 180. The inner shell 180 includes an upper rim 182 protruding upward from the periphery of the shell through-hole 184 formed in the bottom surface thereof.

The upper rim 182 is disposed inside the lower rim 166. An upper end of the upper rim 182 contacts the inner projection 168 which protrudes from an inner circumferential surface of the lower rim 166.

The connector 120 may include a connector body 121 and a connector holder 132. The connector holder 132 may be located above the connector body 121. In addition, the connector body 121 may include a connector plate 122 and a connector pipe 128 extending downward from the connector plate 122.

The connector plate 122 is disposed under the water softener 140. The connector plate 122 is connected to the water softener 140.

An inner sealer 136 is placed around the outer periphery of the connector pipe 128. When the connector 120 is placed above the supply pipe 230, the inner sealer 136 may seal the gap between the connector 120 and the supply pipe 230.

Furthermore, the inner sealer 136 may be formed of a rubber material that can change its configuration. However, the present disclosure is not limited thereto. The inner sealer 136 is disposed in such a way as to make contact with the outer periphery of the connector pipe 128. An outwardly protruding part may be formed on a lower end of the connector pipe 128 so as to keep the inner sealer 136 from moving downward.

The inner sealer 136 includes a sealing projection 136a which protrudes outward. The inner sealer 136 includes a plurality of sealing projections 136a which protrude outward and are vertically spaced apart.

The sealing projection 136a may be formed to have a larger diameter toward the top. In a cross-sectional view, the sealing projection 136a may have the shape of a triangle whose top face has a large area.

The diameter of an outer peripheral edge of the sealing projection 136a may be larger than the diameter of an inner circumferential surface of an inlet port 232 of the supply pipe 230.

The inner sealer 136 includes an upper end projection 136b which is disposed above the sealing projection 136a and protrudes radially outward. The upper end projection 136b may make contact with an upper end portion of the inlet port 232 of the supply pipe 230.

The connector holder 132 is disposed in such a way as to be fixed to the outer periphery of the connector pipe 128. The connector holder 132 may be disposed under the bottom side of the inner reservoir 102. The bottom side of the inner reservoir 102 is disposed between the connector holder 132 and the connector plate 122.

The outer sealer 134 disposed on an outer circumferential surface of the connector holder 132 is disposed in such a way as to make contact with the inner projection 168 of the outer reservoir 160. The outer sealer 134 may be disposed in such a way as to make contact with the upper rim 182 of the inner shell 180.

Part of the construction of the connector 120 protrudes outward from the outer reservoir 160.

A bottom part of the connector 120 is connected to the inlet port 232 of the supply pipe 230. The inner sealer 136 disposed on the outer circumferential surface of the connector pipe 128 contacts the inner circumferential surface of the inlet port 232. The plurality of sealing projections 136a of the inner sealer 136 may make contact with the inner circumferential surface of the inlet port 232.

The inner sealer 136 and the inlet port 232 may overlap 0.3 to 0.7 mm around the entire perimeter. The diameter of an outer peripheral edge of the inner sealer 136 may be 0.3 to 0.7 mm larger than the diameter of an inner peripheral edge of the inlet port 232.

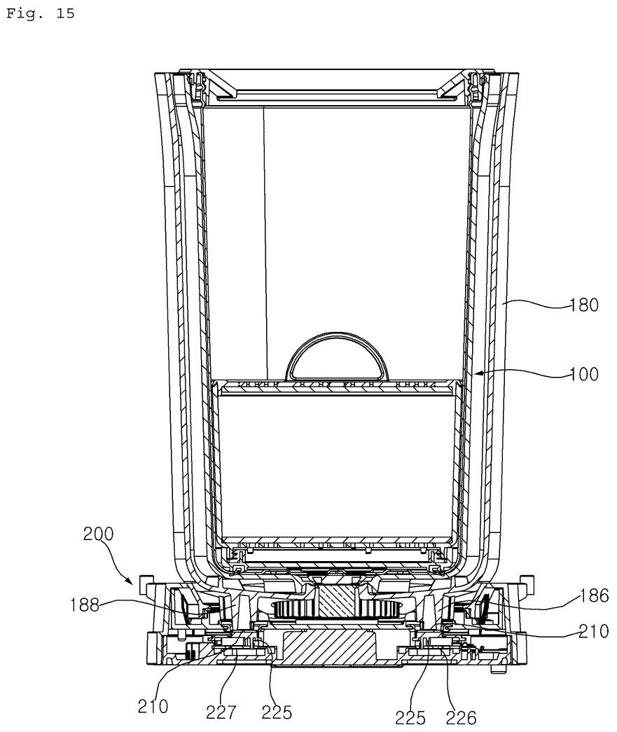

Referring to FIG. 15, the connection between the middle tray 200 and the inner shell while the inner shell is mounted and the configuration of the components related thereto will be described.

The lower protrusions 186 and 188 of the inner shell 180 are disposed on the sensor recesses 208 of the middle tray 200. The lower protrusions 186 and 188 of the inner shell 180 are disposed over the weight sensors 226 and 227 of the middle tray 200. The sensor cover 210 is disposed between the lower protrusion 186 and 188 and the weight sensor 226 and 227. The lower protrusion 186 and 188 is disposed in such a way as to make contact with the sensor cover 210.

The press body 225 is disposed under the sensor cover 210. The press body 225 is disposed between the sensor cover 210 and the weight sensors 226 and 227. In other words, one press body 225 may be located at each of the weight sensors 226 and 227.

When the inner shell 180 is disposed over the middle tray 200, the plurality of lower protrusions 186 and 188 are disposed in such a way as to make contact with the plurality of sensor covers 210, respectively. Thus, the load of the water tank 100 including the inner shell 180 may be transferred to the weight sensors 226 and 227.

Throughout the document, embodiments of the present disclosure have been described with reference to appended drawings. However, the present disclosure is not limited to the embodiments above. Rather, it should be noted that various modifications of the present disclosure may be made by those skilled in the art to which the present disclosure belongs without leaving the technical scope of the present disclosure defined by the appended claims, and these modifications should not be understood individually from the technical principles or perspectives of the present disclosure.

What is claimed is:

1. A humidifier comprising:
a water tank comprising a space configured to store water;
a humidification module disposed below the water tank and configured to generate humidified air using water supplied from the water tank;
a middle tray disposed between the humidification module and the water tank, the middle tray comprising:
a hole through which the humidified air generated by the humidification module is configured to flow;
a tray body;
a tray base disposed below the tray body; and
a tray sealer disposed around the hole and configured to seal between the tray body and the tray base; and
an inner shell comprising a discharge passage through which the humidified air is configured to flow between the water tank and the inner shell, the inner shell contacting the tray body of the middle tray.

2. The humidifier of claim 1, wherein the inner shell further comprises an exhaust connecting tube into which the humidified air generated from the humidification module is configured to flow, and
wherein the exhaust connecting tube contacts the tray sealer.

3. The humidifier of claim 2, wherein the tray sealer comprises an inner protrusion protruding toward a center of the hole, and
wherein the exhaust connecting tube contacts the inner protrusion of the tray sealer.

4. The humidifier of claim 3, wherein the tray sealer further comprises:
an upper tray sealer disposed between the tray base and the tray body;
a lower tray sealer disposed below the tray base; and
a vertical portion connecting the upper tray sealer and the lower tray sealer,
wherein the inner protrusion of the tray sealer protrudes toward the center of the hole from the vertical portion.

5. The humidifier of claim 4, wherein the tray sealer further comprises at least one projection protruding upward toward the tray body, and
wherein the at least one projection is located on a top surface of the upper tray sealer.

6. The humidifier of claim 3, wherein the inner protrusion of the tray sealer is inclined downward toward the center of the hole.

7. The humidifier of claim 1, wherein the middle tray further comprises a tray drain hole located in the tray base, and
wherein the tray drain hole is configured allow water located on the middle tray to pass through the tray drain hole.

8. The humidifier of claim 7, wherein the tray drain hole is disposed between the hole and an edge of the middle tray,
wherein the tray base comprises a guide groove disposed at a side of the hole opposite to the tray drain hole, and
wherein the guide groove is configured to guide water located on the middle tray to the tray drain hole.

9. The humidifier of claim 8, further comprising:
a plurality of weight sensors configured to sense a weight of the water tank, the plurality of weight sensors being located in the middle tray; and
a sensor circuit board connected to the plurality of weight sensors,
wherein the guide groove is configured to guide the water located on the middle tray between the plurality of weight sensors and the sensor circuit board.

10. The humidifier of claim 9, wherein the middle tray further comprises a circuit board partition disposed on one side of a receiving space of the sensor circuit board, and
wherein the guide groove is configured to guide the water located on the middle tray to a rear of the circuit board partition.

11. The humidifier of claim 9, wherein the tray base further comprises a fastening portion disposed in front of the hole and configured to receive a fastening member for connecting the tray body and the tray base, and
wherein the fastening portion is configured to guide water flowing from the guide groove between the plurality of weight sensors and the sensor circuit board.

12. The humidifier of claim 1, wherein the middle tray further comprises:
a weight sensor disposed on the tray base and configured to sense a weight of the water tank; and
a sensor cover disposed on the tray body above the weight sensor, the sensor cover being in contact with the inner shell.

13. The humidifier of claim 12, wherein the tray body comprises:
a sensor recess opened in a region in which the sensor cover is disposed, and
a sensor recess flange that protrudes upward from a circumferential surface of the sensor recess, the sensor recess flange being disposed on the tray body.

14. The humidifier of claim 13, wherein the tray body further comprises a cover rib protruding inward that is disposed on an inner circumferential surface of the sensor recess flange, and
wherein the sensor cover is mounted on the cover rib.

15. The humidifier of claim 12, wherein the inner shell further comprises:
a lower protrusion protruding downward to contact the sensor cover; and
an exhaust connecting tube protruding downward and configured to allow the humidified air generated by the humidification module to pass therethough, and
wherein, when the lower protrusion contacts the sensor cover, the exhaust connecting tube contacts the tray sealer.

16. A humidifier comprising:
a water tank comprising a space configured to store water;
a humidification module disposed below the water tank and configured to generate humidified air using water supplied from the water tank;
a middle tray disposed between the humidification module and the water tank, the middle tray comprising:
a hole through which the humidified air generated by the humidification module is configured to flow;
a weight sensor configured to sense a weight of the water tank; and
an inner shell contacting the middle tray, the inner shell comprising:
a discharge passage through which the humidified air is configured to flow between the water tank;
a lower protrusion protruding downward and configured to press the weight sensor, the lower protrusion comprising a lower side that contacts the middle tray; and
an exhaust connecting tube protruding downward to receive the humidified air generated by the humidification module, a circumferential surface of the exhaust connecting tube contacting the middle tray.

17. The humidifier of claim 16, wherein the middle tray further comprises a tray sealer disposed around the hole and protruding toward a center of the hole, and
wherein the tray sealer contacts the circumferential surface of the exhaust connecting tube.

18. The humidifier of claim 17, wherein the tray sealer comprises an inner protrusion protruding toward the center of the hole, the inner protrusion of the tray sealer being inclined downward toward the center of the hole, and
wherein the inner protrusion of the tray sealer contacts the circumferential surface of the exhaust connecting tube.

19. The humidifier of claim 16, further comprising:
a supply pipe configured to guide water released from the water tank to the humidification module; and
a connector connected to the water tank and the supply pipe, the connector being configured to guide the water held in the water tank to the supply pipe,
wherein an inner sealer is disposed on a circumferential surface of the connector, and
wherein the inner sealer is disposed to contact an inner circumferential surface of the supply pipe.

20. The humidifier of claim 19, wherein the inner sealer and the circumferential surface of the supply pipe overlap one another.
